(19) United States
(12) Patent Application Publication
(10) Pub. No.: US 2005/0229645 A1
(43) Pub. Date: Oct. 20, 2005

(54) Dispenser for washing machine

(75) Inventors: Jong Min Kim, Changwon-si (KR); Yang Hwan No, Changwon-si (KR); Han Ki Cho, Changwon-si (KR); Ho Sung Jang, Gyeongsangnam-do (KR); Dong Hoon Kang, Busan (KR); Jung Hoon Kang, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/034,769

(22) Filed: Jan. 14, 2005

(30) Foreign Application Priority Data
Apr. 14, 2004 (KR) P2004-25969

(51) Int. Cl. A61H 35/00

(52) U.S. Cl. 68/17 R

(57) ABSTRACT

A dispenser for uniformly distributing washing water is provided. The dispenser includes a first passage, at least one second passage, and at least one auxiliary passage. The first passage is provided with washing water. The second passage diverges from the first passage and supplies the washing water to a container that contains a detergent. The auxiliary passage additionally connects the first passage with the second passage.

This application claims the benefit of the Korean Application No. P2004-25969 filed on Apr. 14, 2004, which is hereby incorporated by reference.

### BACKGROUND OF THE INVENTION

1. Field of the Invention

The present invention relates to a washing machine, and more particularly, to a dispenser for supplying washing water to a detergent box.

2. Discussion of the Related Art

Generally, a detergent supplying unit of a washing machine includes a detergent box and a dispenser mounted on the detergent box. The detergent box is a case for containing a detergent, a bleaching agent, a fabric softener, etc. The detergent box is provided with washing water and supplies a detergent and a bleaching agent dissolved in or diluted by the washing water to a tub or a drum of the washing machine. The dispenser supplies the washing water to the detergent box, and particularly, uniformly distributes the washing water to the detergent box. To perform such functions, the dispenser includes passages of the washing water which are formed therein. The passages include through holes that communicate with the detergent box so as to supply the floating washing water to the detergent box.

However, since a pressure of the washing water is lowered in an end portion of the passages, the washing water cannot be uniformly distributed to the detergent box. Thus, the detergent and the bleaching agent stored in the detergent box are not swiftly and uniformly dissolved and washing efficiency may be deteriorated.

### SUMMARY OF THE INVENTION

Accordingly, the present invention is directed to a dispenser for a washing machine that substantially obviates one or more problems due to limitations and disadvantages of the related art.

An object of the present invention is to provide a dispenser for a washing machine capable of uniformly supplying washing water to a detergent box.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dispenser for a washing machine, which includes: a first passage for receiving washing water; at least one second passage which diverges from the first passage and which supplies the washing water to a container that accommodates a detergent; and at least one auxiliary passage for additionally connecting the first passage with the second passage.

The auxiliary passage is connected with an end portion of the second passage and also connected with a starting portion of the first passage. In the meantime, the auxiliary passage may be formed in a diverging portion between the first and the second passages.

The auxiliary passage is so configured as to guide the washing water to the second passage in the same orientation as the flowing of the washing water of the first passage. More specifically, the auxiliary passage is inclined at a predetermined angle with respect to a flowing direction of the washing water in the first passage and the inclination angle is an acute angle.

The first and the second passages are formed by partitions provided to an inside of a case of the dispenser, and the auxiliary passage includes an opening that passes through the partition.

The second passage switches a flowing direction of the washing water. The second passage may allow the washing water to flow to at least a direction opposite to a direction of the first passage. Further, the second passage may switch a flowing direction of the washing water several times, and more desirably, the second passage may allow the washing water to alternately flow to a direction opposite to a direction of the first passage and to the same direction as the direction of the first passage.

According to the present invention, the washing water can be uniformly distributed from the dispenser to the container.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a washing machine according to the present invention;

FIG. 2 is an exploded perspective view illustrating a detergent box of a washing machine according to the present invention;

FIG. 3 is an exploded perspective view illustrating a dispenser of FIG. 2;

FIG. 4 is an exploded perspective view illustrating an operation of a dispenser according to the present invention; and

FIG. 5 is an exploded perspective view illustrating a modified example of a dispenser according to the present invention.

### DETAILED DESCRIPTION OF THE INVENTION

Reference will now be made in detail to the preferred embodiments of the present invention, examples of which are illustrated in the accompanying drawings.

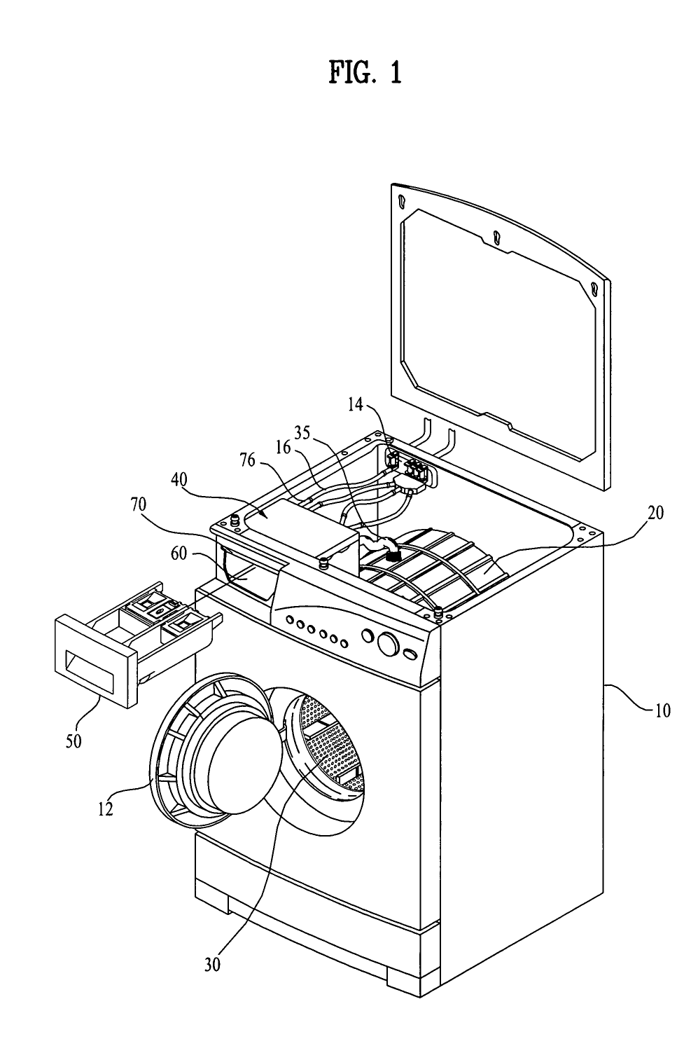

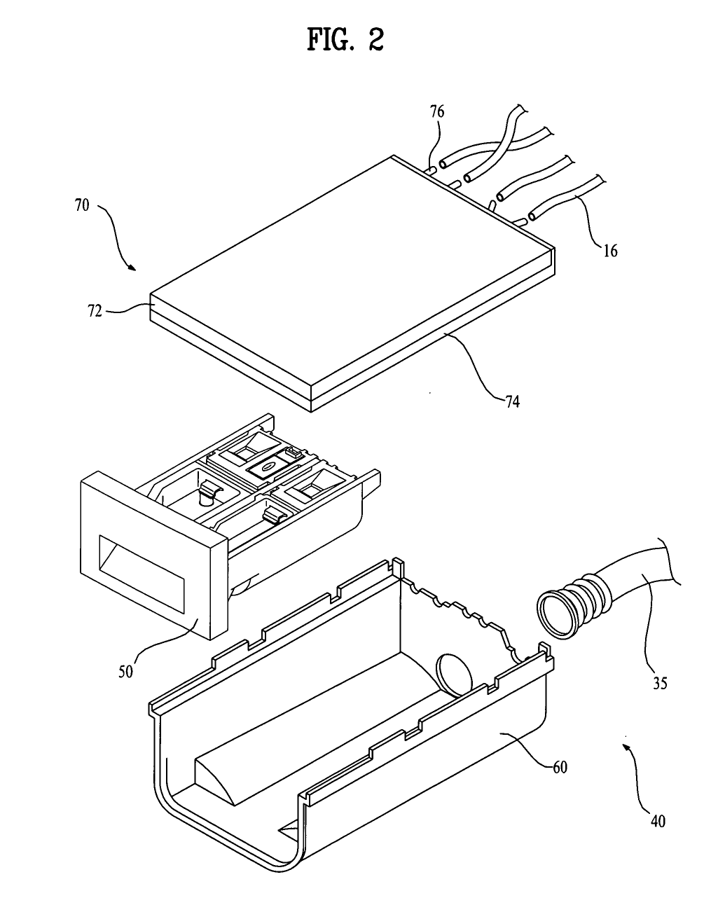

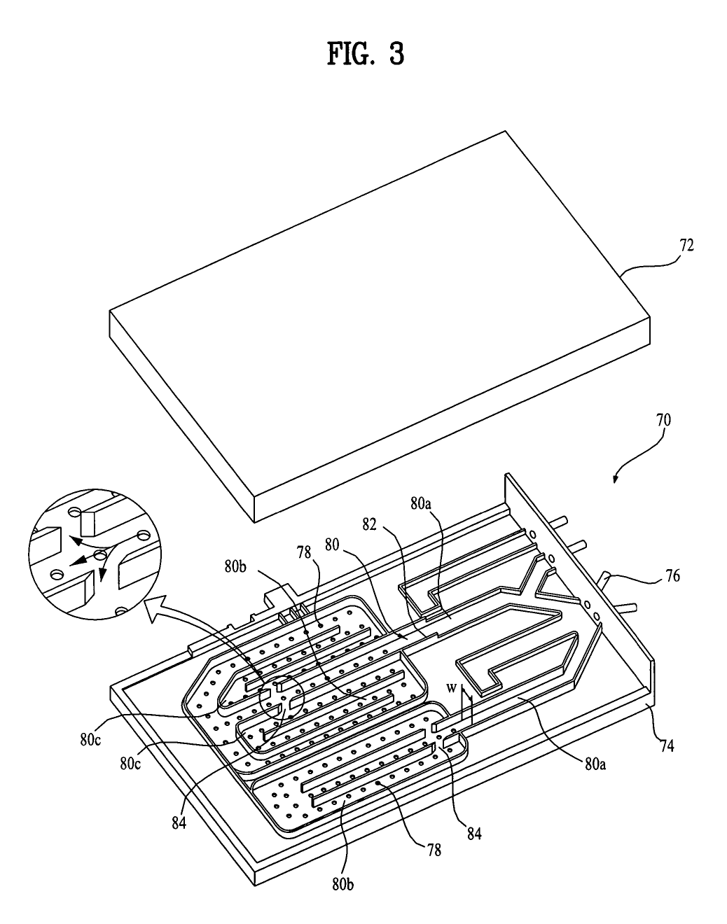

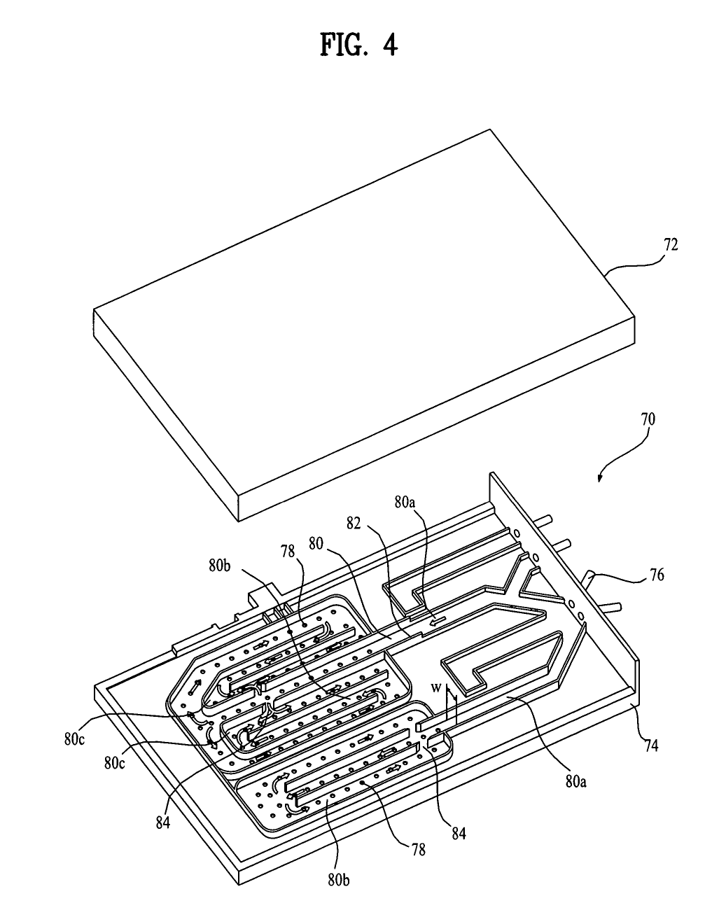

FIG. 1 is a perspective view of a washing machine according to the present invention, FIG. 2 is an exploded perspective view illustrating a detergent box of a washing machine according to the present invention, and FIGS. 3 and 4 are exploded perspective views illustrating a dispenser of FIG. 2.

The washing machine of the present invention includes: a cabinet 10 having a door 12 installed on its front side; a tub 20 mounted in an inside of the cabinet 10; and a drum 30 installed in an inside of the tub 20, for washing the laundry. Further, the washing machine has: a detergent supplying unit 40 for supplying a detergent to an inside of the tub 20; and a bellows 35 for connecting the detergent supplying unit 40 with the tub 20.

The cabinet 10 has a water-supply valve 14 for supplying washing water to the detergent supplying unit 40 and the water-supply valve 14 supplies hot water or cold water to the detergent box 50. The water-supply valve 14 is connected with the detergent box 50 by a hose 16.

As illustrated in detail in FIG. 2, the detergent supplying unit 40 is installed in a housing 60 and includes: a container 50 for storing a detergent or a bleaching agent, a fabric softener; and a dispenser 70 installed on the container 50, for supplying washing water to the container 50. The housing 60 mounts the bellows 35 that is connected with the tub 20. The washing water supplied from the dispenser 70 is supplied to the container 50 to dissolve or dilute a detergent and a bleaching agent. After that, the detergent and the bleaching agent mixed with the washing water are supplied to the tub 20 through the bellows 35.

A variety of kinds of detergents, bleaching agents, fabric softeners for use in washing is stored in a relevant partition of the container 50. The container 50 operates as a kind of drawer. That is, a user can draw the container 50 from the housing 60 or put the container 50 again into the housing 60 whenever necessary.

The dispenser 70 distributes the washing water supplied from the hose 16 into the container 50. Referring to FIG. 3, the dispenser 70 includes an upper plate 72 and a lower plate 74 and has, on its one side, a connection part 76 with which the hose 16 is connected. The dispenser 70 includes: a first passage 80a for communicating with the connection part 76 to receive the washing water; and at least one second passage 80b which diverges from the first passage 80a to distribute the washing water to the container 50. Referring to FIG. 3, partitions 82 are installed between the upper and the lower plates 72 and 74. The first ant the second passages 80a and 80b are substantially formed by these partitions 82. Further, the first ant the second passages 80a and 80b have the same width.

The second passage 80b includes a plurality of holes 78 that communicate with the container 50. The washing water falls down to the container through the holes 78. Further, the second passage 80b is so configured as to switch a flowing direction of the washing water. More specifically, the second passage 80b allows the washing water to flow to other direction different from a direction of the first passage 80a. The second passage 80b may be so configured as to allow the washing water to flow to at least a direction opposite to the direction of the first passage 80a for maximum use of a limited size of the dispenser 70. Further, the second passage 80b may be so configured as to switch a flowing direction of the washing water several times. The second passage 80b is illustrated in detail on a front side of the dispenser 70 of FIGS. 3 and 4. In the second passage 80b, the washing water flows to both a direction opposite to the direction of the first passage 80a and the same direction as the direction of the first passage 80a. As illustrated in the drawings, the washing water may alternately flow along the second passage 80b to the direction opposite to the direction of the first passage 80a and flow along the second passage 80b to the same direction as the direction of the first passage 80a. That is, the flowing direction of the washing water is alternately switched as much as 180° several times. The second passage 80b makes maximum use of a space of the dispenser 70 to be extended long. Accordingly, the second passage 80b can uniformly supply the washing water to the container 50. Likewise, the first passage 80a can also partially include the holes 78 and thus can supply the washing water to the container 50 so that the washing water may be more uniformly distributed.

Nevertheless, a flux and a speed of the washing water are deteriorated due to the long length of the second passage 80b and thus the washing water may not be uniformly supplied to the container 50 in a swift manner. Therefore, the dispenser additionally includes an auxiliary passage 84 to compensate the flux and the speed of the washing water. The auxiliary passage 84 includes an opening that substantially passes through the partitions 82. The auxiliary passage 84 additionally connects the first passage 80a with the second passage 80b and directly guides the washing water of the first passage 80a to the second passage 80b. Accordingly, the auxiliary passage 84 additionally supplies the washing water to the second passage 80b, thereby making uniform the flux and the speed of the washing water in an inside of the second passage 80b so that the washing water may be uniformly supplied to the container 50.

Further, since deterioration in the flux and the speed of the washing water is particularly generated much at the end portion of the second passage 80b, the auxiliary passage 84 may be connected with the end portion of the second passage 80b. Still further, the flux and the speed of the washing water are great at a starting portion of the first passage 80a, the auxiliary passage 84 may be connected with the starting portion of the first passage 80a so that the washing water may be swiftly supplied to the second passage 80b. Another further, as enlarged by an arrow in FIG. 3, the auxiliary passage 84 is inclined at a predetermined angle with respect to a flowing direction of the washing water in the first passage 80a. At this point, the predetermined angle is an acute angle. Therefore, the auxiliary passage 84 guides the washing water to the second passage 80b in the same orientation as the flowing of the washing water in the first passage 80a, thereby facilitating inflow of the washing water to the second passage 80b.

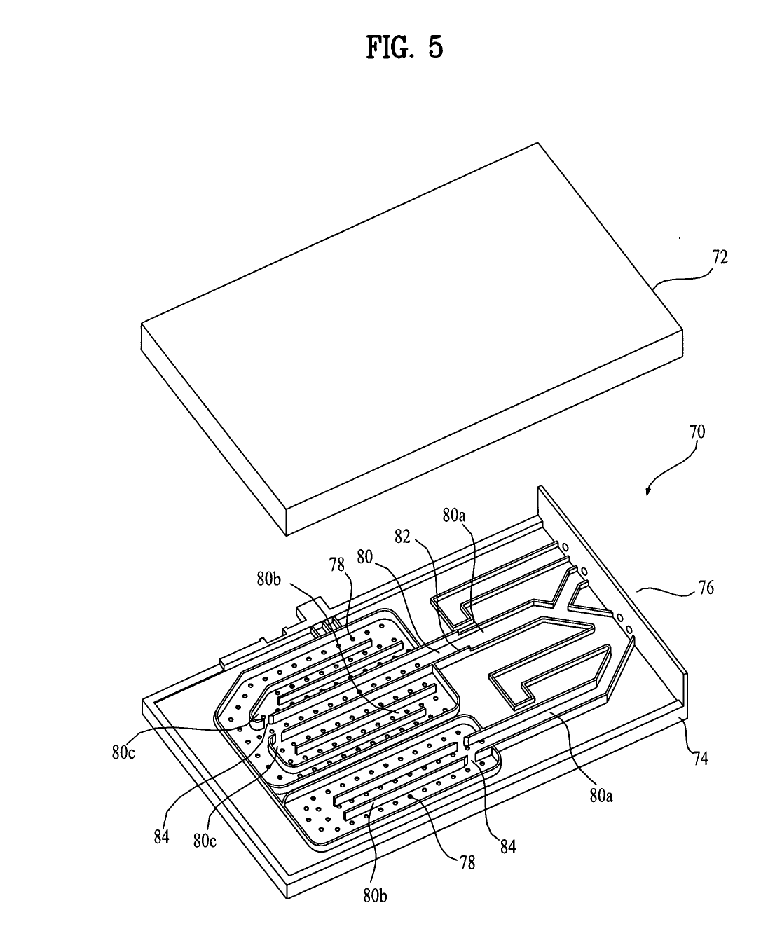

Alternatively, referring to FIG. 5, the auxiliary passage 84 may be formed in a diverging portion 80c between the first passage 80a and a first passage 80. The auxiliary passage 84 alleviates accumulation of the washing water generated at the diverging portion 80c by switching the flowing direction of the washing water and, simultaneously, can directly supply the washing water to the second passage 80b so that uniform flux and speed of the washing water may be secured in the second passage 80b.

The dispenser 70 can include a plurality of auxiliary passages if necessary so as to more efficiently supply the washing water to the container 50.

Operation of the dispenser will be described below.

The washing water that has been supplied to the hose 16 through the water-supply valve 14 is supplied to the connection part 76 of the dispenser 70 and the washing water supplied to the connection part 76 sequentially flows to the first and the second passages 80a and 80b. During the flowing to the first an the second passages 80a and 80b, the washing water falls down through the holes 78 to the container 50 arranged in a lower side of the dispenser 70. The fallen washing water dissolves the detergent contained in the container 50 and then is supplied to the tub 20 through the bellows 35 connected with the housing 60.

In the meantime, part of the washing water in the first passage 80a is directly supplied to the second passage 80b through the auxiliary passage 84, and the supplied washing water flows together with the washing water of the second passage 80b, so that uniform amount of washing water is supplied to the container 50 through a plurality of holes 78.

As described above, the dispenser uniformly distributes the washing water to the container by compensating the flux and the speed of the washing water at the end portion of the passages using the auxiliary passage. Therefore, the detergent, the bleaching agent, the softener are uniformly and swiftly dissolved or diluted at the container, whereby washing efficiency is increased.

It will be apparent to those skilled in the art that various modifications and variations can be made in the present invention. Thus, it is intended that the present invention covers the modifications and variations of this invention provided they come within the scope of the appended claims and their equivalents.

1. A dispenser for a washing machine, comprising:
a first passage for receiving washing water;
at least one second passage which diverges from the first passage and which supplies the washing water to a container that accommodates a detergent; and
at least one auxiliary passage for additionally connecting the first passage with the second passage.

2. The dispenser of claim 1, wherein the auxiliary passage is connected with an end portion of the second passage.

3. The dispenser of claim 1, wherein the auxiliary passage is connected with a starting portion of the first passage.

4. The dispenser of claim 1, wherein the auxiliary passage connects a starting portion of the first passage with an end portion of the second passage.

5. The dispenser of claim 1, wherein the auxiliary passage guides the washing water of the first passage to the second passage.

6. The dispenser of claim 1, wherein the auxiliary passage guides the washing water to the second passage in the same orientation as the flowing of the washing water in the first passage.

7. The dispenser of claim 1, wherein the auxiliary passage is inclined at a predetermined angle with respect to a flowing direction of the washing water in the first passage.

8. The dispenser of claim 7, wherein the predetermined angle is an acute angle.

9. The dispenser of claim 1, wherein the first and the second passages are formed by partitions provided to an inside of a case of the dispenser.

10. The dispenser of claim 9, wherein the auxiliary passage includes openings that pass through the partitions.

11. The dispenser of claim 1, wherein the second passage switches a flowing direction of the washing water.

12. The dispenser of claim 1, wherein the second passage allows the washing water to flow to a direction different from a direction of the first passage.

13. The dispenser of claim 1, wherein the second passage allows the washing water to flow to a direction opposite to a direction of the first passage.

14. The dispenser of claim 1, wherein the second passage switches a flowing direction of the washing water several times.

15. The dispenser of claim 1, wherein the second passage allows the washing water to flow to a direction opposite to a direction of the first passage or to the same direction as the direction of the first passage.

16. The dispenser of claim 1, wherein the second passage allows the washing water to alternately flow to a direction opposite to a direction of the first passage and to the same direction as the direction of the first passage.

17. The dispenser of claim 1, wherein the second passage allows the washing water to fall down.

18. The dispenser of claim 1, wherein the second passage includes through holes that communicate with the container.

19. The dispenser of claim 1, wherein the first passage supplies the washing water to the container.

20. The dispenser of claim 1, wherein the auxiliary passage is formed at a diverging portion between the first and the second passages.
